(19) United States
(12) Patent Application Publication
(10) Pub. No.: US 2016/0127196 A1
(43) Pub. Date: May 5, 2016

(54) DEVICE CONNECTION PROMPT

(71) Applicant: Xiaomi Inc., Beijing (CN)

(72) Inventors: Qiang Fu, Beijing (CN); Ziguang Gao, Beijing (CN); Yang Wang, Beijing (CN)

(21) Appl. No.: 14/729,022

(22) Filed: Jun. 2, 2015

Related U.S. Application Data
(63) Continuation of application No. PCT/CN2015/072035, filed on Jan. 30, 2015.

(30) Foreign Application Priority Data
Oct. 29, 2014 (CN) 201410593971.1

(51) Int. Cl. H04L 12/24; G06F 3/0481; G06F 3/0482

(52) U.S. Cl. CPC H04L 41/22; G06F 3/0482; G06F 3/04817

(57) ABSTRACT

The present disclosure relates to a method and a controlling node for providing a device connection prompt. The method includes receiving a connecting instruction to connect a device; obtaining a connection property of the connected device; and displaying prompting information corresponding to the connection property according to the connection property of the connected device.

### CROSS REFERENCE TO RELATED APPLICATION

This application is a Continuation of International Application No. PCT/CN2015/072035, filed on Jan. 30, 2015, which is based upon and claims priority and benefits of Chinese Patent Application No. 201410593971.1, filed with State Intellectual Property Office on Oct. 29, 2014, the entire content of which is incorporated herein by reference.

### TECHNICAL FIELD

Embodiments of the present invention generally relate to communication technology, and more particularly, to a method and a controlling device for providing a device connection prompt.

### BACKGROUND

A smart home is a management system, based on a house, integrated with facilities related to a household life by using a comprehensive wiring technology, a network communication technology, a security technology of a smart home-system design project, an audio and video technology. The smart home builds an efficient management system of the facilities related to the household life and daily household matters, and improves safety, accessibility, comfort and artistry of the household life and achieves a eco-friendly living environment. Compared with an ordinary home, apart from the conventional living function, the smart home has a living environment combined with building, network communication and management, which is efficient, comfortable, safe, convenient and eco-friendly, and also the smart home further provides a function for omni-directional mutual information exchange.

In a related art, each smart device must be mounted, connected and set according to steps illustrated in a product manual before it is used. However, it is troublesome to set the product while reading the product manual, and if the product manual is lost, it will be inconvenient to use the product.

### SUMMARY

According to a first aspect of embodiments of the present disclosure, there is provided a method for providing a device connection prompt in a controlling node, comprising: receiving a connecting instruction to connect a device; obtaining a connection property of the connected device; and displaying prompting information corresponding to the connection property according to the connection property of the connected device.

According to a second aspect of embodiments of the present disclosure, there is provided a controlling node for providing a device connection prompt, comprising: a processor; a memory configured to store an instruction executable by the processor; wherein the processor is configured to perform: receiving a connecting instruction to connect a device; obtaining a connection property of the connected device; and displaying prompting information corresponding to the connection property according to the connection property of the connected device.

According to a third aspect of embodiments of the present disclosure, there is provided a non-transitory computer-readable storage medium having stored therein instructions that, when executed by a processor of a controlling node, causes the controlling node to perform a method for providing a device connection prompt, the method comprising: receiving a connecting instruction to connect a device; obtaining a connection property of the connected device; and displaying prompting information corresponding to the connection property according to the connection property of the connected device.

The technical solution provided by embodiments of the present disclosure can display the content corresponding to the connection property of the connected device, which saves a switching operation process between the product specification and the product setting and results in a simple operation, and thus it is intuitive and convenient to provide the prompting information.

It is to be understood that both the foregoing general description and the following detailed description are exemplary and explanatory only and are not restrictive of the disclosure, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for providing a device connection prompt according to an exemplary embodiment;

FIG. 2a and FIG. 2b are schematic diagrams illustrating a device list according to an exemplary embodiment;

FIG. 3a and FIG. 3b are schematic diagrams illustrating device connection prompting pages of different devices according to an exemplary embodiment;

FIG. 4 is a schematic diagram illustrating a setting page to be jumped to according to an exemplary embodiment;

FIG. 5 is a flow chart showing a method for providing a device connection prompt according to an exemplary embodiment;

FIG. 6 is a block diagram illustrating an apparatus for providing a device connection prompt according to an exemplary embodiment;

FIG. 7 is a block diagram illustrating a controlling node for providing a device connection prompt according to an exemplary embodiment;

FIG. 8 is a block diagram illustrating another controlling node for providing a device connection prompt according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of devices and methods consistent with aspects related to the disclosure as recited in the appended claims.

Currently, smart home appliances have been used in families and various application scenarios widely. When a user installs a device, it is required for him to find a product manual and to install the device while reading the product manual with reference to a corresponding application program (APP), thus resulting in a complex operation.

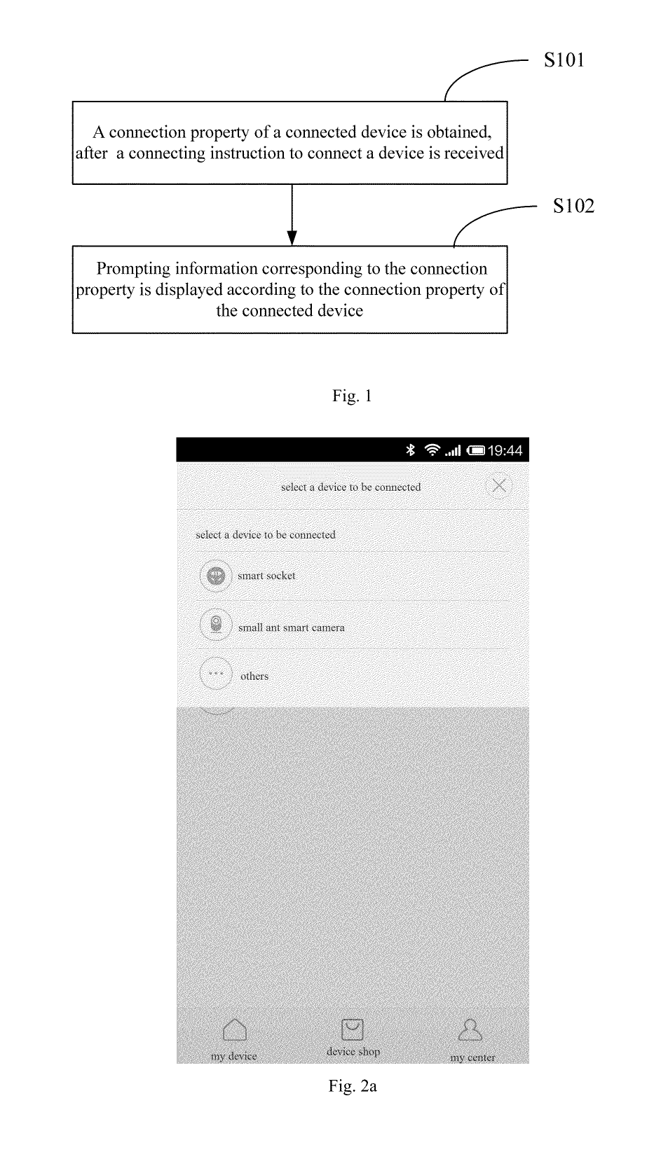

FIG. 1 is a flow chart showing a method for providing a device connection prompt in a controlling node according to an exemplary embodiment. The controlling node may include any terminal device with controlling function, such as a mobile phone or a router. As shown in FIG. 1, the method includes following steps.

In step S101, a connection property of a connected device is obtained, after a connecting instruction to connect a device is received.

In step S102, prompting information corresponding to the connection property is displayed according to the connection property of the connected device.

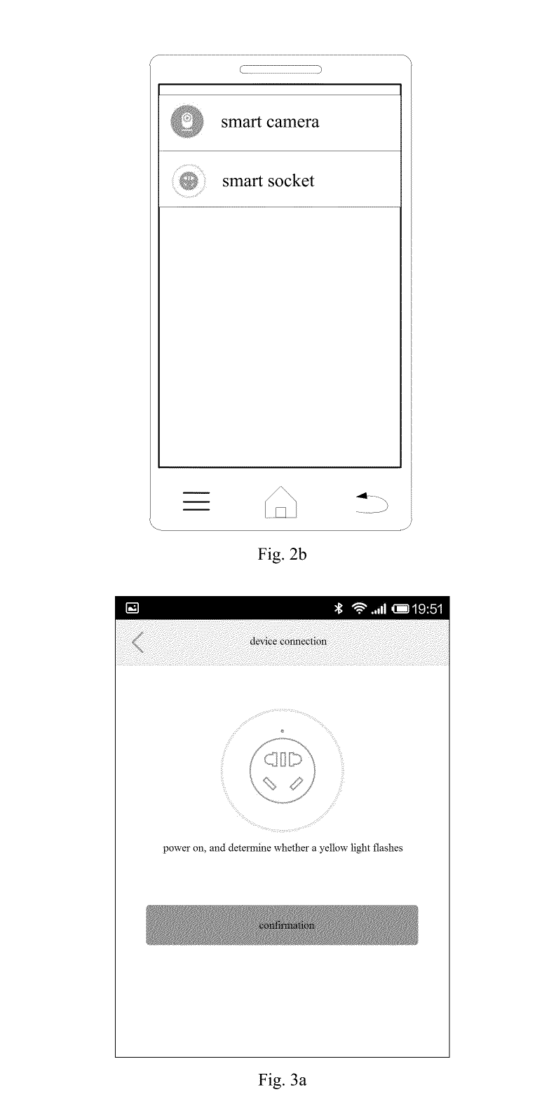

One or more identifiers (such as an icon, a name, etc.) of a connected device are displayed in a device list in a page, in which the identifiers are configured to indicate an identity of the connected device. For example, the devices to be connected are a smart socket and a smart camera, as shown in FIGS. 2a and 2b, the icons and names of the two devices are displayed in a list so as to prompt the user which device is to be connected. Certainly, the identifiers of the devices are not limited to the display in the list, but in other displaying manners that have a same effect, such as a Matts, a Nine Patch or a scrolling page, etc.

In an embodiment, the connecting instruction to connect the device is received, and includes following steps: it is received a message indicating that an icon of a connected device is selected; or it is received a message indicating that a column or a row in which the icon of the connected device is located is selected; or it is received a message indicating that the connected device is selected by a menu operation. For example, when the connected device is displayed through the icon thereof and it is received a message indicating that the icon of the device is clicked, it is determined that the connecting instruction to connect the device is received. When the icon occupies a small space in the column or the row in which the icon is located and it is received a message indicating that the column or the row in which the icon of the connected device is located is selected, apart from clicking the icon, it is also determined that the connecting instruction to connect the device is received. In addition, the connected device may be selected by the menu operation. The above-described clicking operation is only exemplary, and other selecting manners such sliding and pressing may be used.

In an embodiment, the connection property of the connected device is obtained, and includes following steps: an identifier of the connected device is obtained; and the connection property of the connected device is obtained according to a pre-stored correspondence between the identifier and the connection property. For example, the correspondence between the identifier and the connection property may be pre-stored locally, or may be pre-stored at a server side or a router side. When the correspondence between the identifier and the connection property is pre-stored at the server side or the router side, the terminal device may send a request to obtain the correspondence to the server side or the router side and receive the correspondence between the identifier and the connection property returned by the server side or the router side.

The connection property may include a physical property of the device, such as one or more of an indicator light, an on-off key, a display screen, a cooling fin, and etc. The connection property also may include a functional property of the device, such as one or more of a Bluetooth function, an infrared function, a Wi-Fi function, and etc.

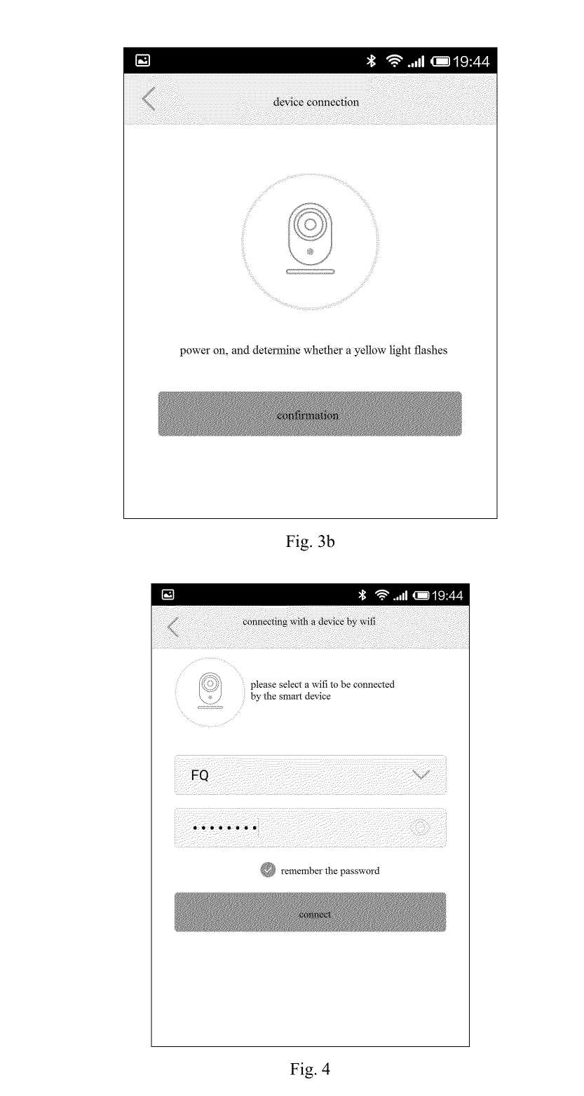

In an embodiment, the prompting information corresponding to the connection property is displayed, and includes following steps: a current page jumps to a device connection prompting page and the prompting information corresponding to the connection property is displayed in the device connection prompting page. For example, when it is needed to display the prompting information corresponding to the connection property, the prompting information may be displayed directly in the current page, or the prompting information may be displayed in the device connection prompting page after jumping to the device connection prompting page. For example, when the smart socket in FIG. 2 is selected, the current page jumps to the device connection prompting page as shown in FIG. 3a. When the smart camera in FIG. 2 is selected, the current page jumps to the device connection prompting page as shown in FIG. 3b.

In an embodiment, the prompting information corresponding to the connection property is displayed and includes a following step: text prompting information and image information corresponding to the text prompting information are displayed. For example, as shown in FIG. 3a, the prompting information includes not only the text information such as “power on, and determine whether a yellow light flashes”, but also the image information corresponding to the text information, which indicates that which one is the connected device. Moreover, the image information may be a static image or a dynamic image. For example, the image information is corresponding to a current state of the connected device. For instance, as shown in FIG. 3a, a position representing the indicator light in the image may have a light flashing effect, which may be a predetermined constant flashing effect or may be presented according to the current state of the connected device. For example, the current state of the connected device is in an indicator light flashing state, and thus the indicator light in the image of the prompting information also flashes. Certainly, the current state of the connected device may be set to be corresponding to other display effects, such as an animation effect and a sound effect indicating that the device is normal.

Furthermore, the prompting information may include an option for continuing setting. For example, as shown in FIG. 3b, when the state of the connected device is consistent with the prompting information, the setting proceeds to a next step by selecting a “confirmation” option and jumps to a setting page as shown in FIG. 4.

In an embodiment, after the prompting information corresponding to the connection property is displayed, the current state of the connected device may be obtained to display. For example, if the prompting information is “yellow light flashing changing into blue light flashing indicates a successful connection”, the image information in the prompting information will change after the successful connection, i.e., the yellow light flashing changes into the blue light flashing. The text information in the prompting information also changes into “connected successfully” correspondingly.

In an embodiment, if the current state of the connected device is in an abnormal state, a prompt to manage the abnormal state will be displayed. For example, if the connected device crashes, a normal connection cannot be completed, then the prompting information may be a prompt showing “please restart the device”.

The technical solution provided by embodiments of the present disclosure can display the prompting information corresponding to the connect ion property of the connected device, thereby eliminates an operation switching process between an operation of a device manual and an operation of setting a product, which results in a simplified operation, and thus, provides a more intuitive and more convenience prompting information.

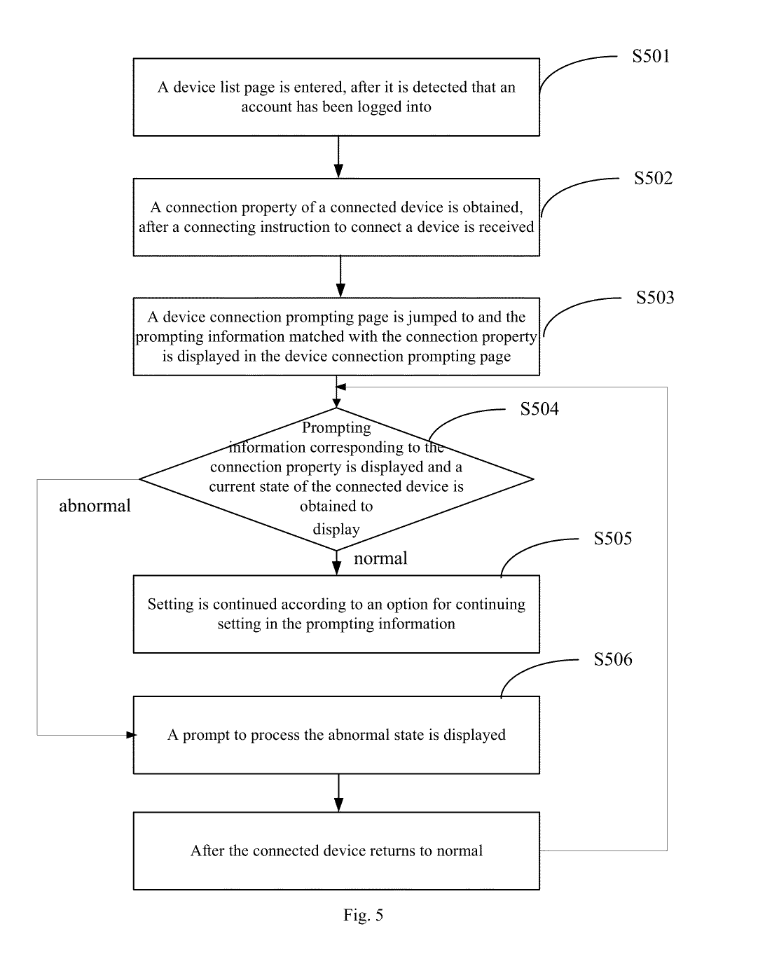

FIG. 5 is a flow chart showing a method for providing a device connection prompt in a controlling node according to an exemplary embodiment. The controlling node may include any terminal device with controlling function, such as a mobile phone or a router. As shown in FIG. 5, the method includes following steps.

In step S501, a device list page is entered, after it is received a message indicating that an account has been logged into.

In step S502, a connection property of a connected device is obtained, after a connecting instruction to connect a device is received. An identifier of the connected device is obtained, and the connection property of the connected device is obtained according to a pre-stored correspondence between the identifier and the connection property. The connection property may include a physical property of the device, such as one or more of an indicator light, an on-off key, a display screen, a cooling fin, and etc. The connection property also may include a functional property of the device, such as one or more of a Bluetooth function, an infrared function, a Wi-Fi function, and etc.

In step S503, a current page jumps to a device connection prompting, and the prompting information corresponding to the connection property is displayed in the device connection prompting page. The prompting information may also be displayed in the current page directly.

In step S504, the prompting information corresponding to the connection property is displayed and a current state of the connected device is obtained to display. If the current state of the connected is a normal state, step S505 is executed; if the current state of the connected device is an abnormal state, step S506 is executed. For example, the prompting information includes text information “power on and determine whether a yellow light flashes”, and also a current state of the indicator light of the connected device is obtained.

In step S505, setting is continued according to an option for continuing the setting in the prompting information. For example, as shown in FIG. 3b, when the state of the connected device is consistent with the prompting information, the setting proceeds to a next step by selecting a “confirmation” option and jumps to a setting page as shown in FIG. 4.

In step S506, a prompt to manage the abnormal state is displayed, and after the connected device returns to normal, step S504 is returned to. For example, if an abnormal situation occurs in the connected device and a normal connection cannot be completed, so the prompting information may display options such as “Please long press the power button”, “Please make sure the power is switched on”, and etc.

The method provided by embodiments of the present disclosure can display the prompting information corresponding to the connection property of the connected device, thereby eliminates an operation switching process between an operation of a device manual and an operation of setting a product, which results in a simplified operation, and thus, provides a more intuitive and more convenience prompting information.

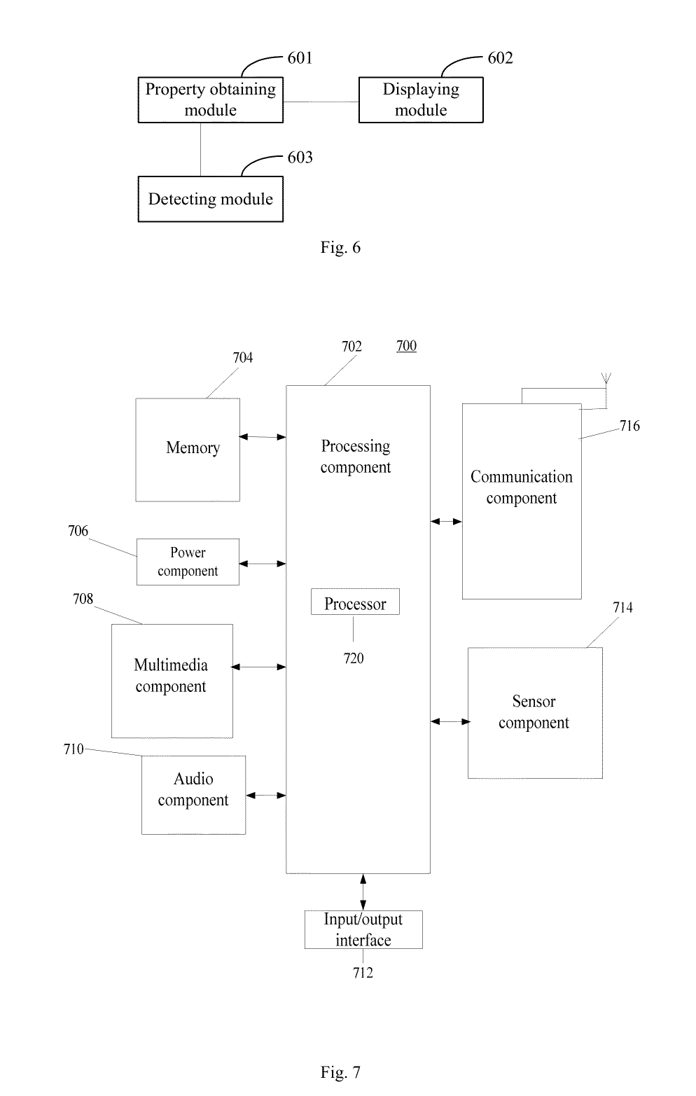

Embodiments of the present disclosure provide an apparatus for providing a device connection prompt, as shown in FIG. 6. The apparatus may includes: a property obtaining module 601, configured to obtain a connection property of a connected device after receiving a connecting instruction to connect a device; a displaying module 602, configured to display prompting information corresponding to the connection property according to the connection property of the connected device.

In an embodiment, the apparatus further includes: a detecting module 603, configured to receive a message indicating that an icon of a connected device is selected; or configured to receive a message indicating that a column or a row in which the icon of the connected device is located is selected; or configured to receive a message indicating that the connected device is selected by a menu operation.

In an embodiment, the property obtaining module 601 is configured to obtain an identifier of the connected device, and to obtain the connection property of the connected device according to a pre-stored correspondence between the identifier and the connection property.

In an embodiment, the displaying module 602 is configured to display the prompting information corresponding to the connection property in a device connection prompting page after jumping to the device connection prompting page.

In an embodiment, the displaying module 602 is configured to display text prompting information and image information corresponding to the text prompting information.

In an embodiment, the displaying module 602 is configured in such a manner that the image information is corresponding to a current state of the connected device.

In an embodiment, the displaying module 602 is configured to display an option for continuing setting.

In an embodiment, the displaying module 602 is configured to obtain and display the current state of the connected device, and display a prompt to manage an abnormal state, if the current state of the connected device is the abnormal state.

The technical solution provided by embodiments of the present disclosure can display prompting information corresponding to the connection property of the connected device, thereby eliminates an operation switching process between an operation of a device manual and an operation of setting a product, which results in a simplified operation, and thus, provides a more intuitive and more convenience prompting information.

With respect to the apparatus in the above embodiments, the specific manners for performing operations for individual modules therein have been described in detail in the embodiments regarding the methods for providing the device connection prompt, which will not be elaborated herein.

A non-transit computer-readable storage medium is provided, in which when the instructions in the storage medium are executed by the processor of a terminal device, the terminal device can execute a method for providing a device connection prompt, including obtaining a connection property of a connected device after receiving a connecting instruction to connect a device, and displaying prompting information corresponding to the connection property according to the connection property of the connected device.

In an embodiment, the connecting instruction to connect the device is received, and includes: receiving a message indicating that an icon of a connected device is selected; or receiving a message indicating that a column or a row in which the icon of the connected device is located is selected; or receiving a message indicating that the connected device is selected by a menu operation.

FIG. 7 is a block diagram illustrating a controlling node 700 for providing a device connection prompt, according to an exemplary embodiment and the device is suitable for a terminal device. For example, the controlling node 700 may be a mobile phone, a television, a computer, a digital broadcast terminal, a messaging device, a gaming console, a tablet, a medical device, exercise equipment, a personal digital assistant, and the like.

Referring to FIG. 7, the controlling node 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the controlling node 700 such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the controlling node 700. Examples of such data include instructions for any applications or methods operated on the controlling node 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the controlling node 700. The power component 706 may include a power management system, one or more power sources, and any other components associated with the generation, management, and distribution of power in the controlling node 700.

The multimedia component 708 includes a screen providing an output interface between the controlling node 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the controlling node 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (MIC) configured to receive an external audio signal when the controlling node 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the controlling node 700. For instance, the sensor component 714 may detect an open/closed status of the controlling node 700, relative positioning of components, e.g., the display and the keypad, of the controlling node 700, a change in position of the controlling node 700 or a component of the controlling node 700, a presence or absence of user contact with the controlling node 700, an orientation or an acceleration/deceleration of the controlling node 700, and a change in temperature of the controlling node 700. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 716 is configured to facilitate communication, wired or wirelessly, between the controlling node 700 and other devices. The controlling node 700 can access a wireless network based on a communication standard, such as Wi-Fi, 2G, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identifier (RFID) technology, an infrared data association (IrDA) technology, an ultra-wideband (UWB) technology, a Bluetooth (BT) technology, and other technologies.

In exemplary embodiments, the controlling node 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 704, executable by the processor 720 in the controlling node 700, for performing the above-described methods. For example, the non-transitory computer-readable storage medium may be a ROM, a RAM, a CD-ROM, a magnetic tape, a floppy disc, an optical data storage device, and the like.

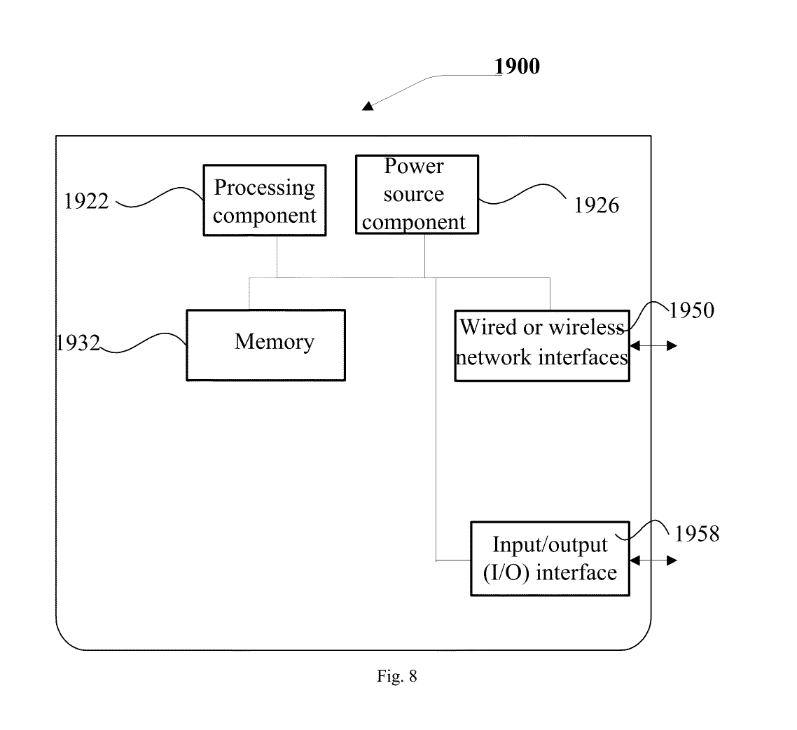

FIG. 8 is a block diagram illustrating another controlling node 1900 for providing a device connection prompt according to an exemplary embodiment. For example, the controlling node 1900 may be provided as a server. With reference to FIG. 8, the controlling node 1900 may include a processing component 1922, and further include one or more processors and a memory resource represented by a memory 1932, which is configured to store instructions such as application programs executable by the processing component 1922. The application program stored in the storage medium 1930 includes one or more modules, and each module is corresponding to a series of instructions. Furthermore, the processing component 1920 is configured to execute the series of instructions to execute the above method.

The controlling node 1900 may further include a power source component 1926 configured to execute a power source management, one or more wired or wireless network interfaces 1950 configured to access the controlling node 1900 to internet, and an input/output (I/O) interface 1958. The controlling node 1900 may be operated based an operating systems 1941 stored in the memory 1932, such as Windows Server™, Mac OS X™, Unix™, Linux™ and FreeBSD™.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for providing a device connection prompt in a controlling node, comprising:
receiving a connecting instruction to connect a device;
obtaining a connection property of the connected device; and
displaying prompting information corresponding to the connection property according to the connection property of the connected device.

2. The method according to claim 1, wherein receiving the connecting instruction to connect the device comprises:
receiving a message indicating that an icon of the device is selected.

3. The method according to claim 1, wherein receiving the connecting instruction to connect the device comprises:
receiving a message indicating that a column or a row in which an icon of the device is located is selected.

4. The method according to claim 1, wherein receiving the connecting instruction to connect the device comprises:
receiving a message indicating that the device is selected by a menu operation.

5. The method according to claim 1, wherein obtaining the connection property of the connected device comprises:
obtaining an identifier of the connected device; and
obtaining the connection property of the connected device according to a pre-stored correspondence between the identifier and the connection property.

6. The method according to claim 1, wherein displaying the prompting information corresponding to the connection property comprises:
jumping to a device connection prompting page; and
displaying the prompting information corresponding to the connection property in the device connection prompting page.

7. The method according to claim 1, wherein displaying the prompting information corresponding to the connection property comprises:
displaying text prompting information and image information corresponding to the text prompting information, wherein the image information is corresponding to a current state of the connected device.

8. The method according to claim 7, wherein displaying the prompting information corresponding to the connection property further comprises:
displaying an option for continuing setting.

9. The method according to claim 7, wherein displaying the prompting information corresponding to the connection property further comprises:
obtaining and displaying a current state of the connected device; and
if the current state of the connected device is an abnormal state, displaying a prompt to manage the abnormal state.

10. A controlling node for providing a device connection prompt, comprising:
a processor;
a memory configured to store an instruction executable by the processor;
wherein the processor is configured to perform:
receiving a connecting instruction to connect a device;
obtaining a connection property of the connected device; and
displaying prompting information corresponding to the connection property according to the connection property of the connected device.

11. The controlling node according to claim 10, wherein receiving the connecting instruction to connect the device comprises:
receiving a message indicating that an icon of the device is selected.

12. The controlling node according to claim 10, wherein receiving the connecting instruction to connect the device comprises:
receiving a message indicating that a column or a row in which an icon of the device is located is selected.

13. The controlling node according to claim 10, wherein receiving the connecting instruction to connect the device comprises:
receiving a message indicating that the device is selected by a menu operation.

14. The controlling node according to claim 10, wherein obtaining the connection property of the connected device comprises:
obtaining an identifier of the connected device; and
obtaining the connection property of the connected device according to a pre-stored correspondence between the identifier and the connection property.

15. The controlling node according to claim 10, wherein displaying the prompting information corresponding to the connection property comprises:
jumping to a device connection prompting page; and
displaying the prompting information corresponding to the connection property in the device connection prompting page.

16. The controlling node according to claim 10, wherein displaying the prompting information corresponding to the connection property comprises:
displaying text prompting information and image information corresponding to the text prompting information, wherein the image information is corresponding to a current state of the connected device.

17. The controlling node according to claim 16, wherein displaying the prompting information corresponding to the connection property further comprises:
displaying an option for continuing setting.

18. The controlling node according to claim 16, wherein displaying the prompting information corresponding to the connection property further comprises:
obtaining and displaying a current state of the connected device; and
if the current state of the connected device is an abnormal state, displaying a prompt to manage the abnormal state.

19. A non-transitory computer-readable storage medium having stored therein instructions that, when executed by a processor of a controlling node, causes the controlling node to perform a method for providing a device connection prompt, the method comprising:
receiving a connecting instruction to connect a device;
obtaining a connection property of the connected device; and
displaying prompting information corresponding to the connection property according to the connection property of the connected device.
